(19) United States
(12) Patent Application Publication
(10) Pub. No.: US 2011/0300345 A1
(43) Pub. Date: Dec. 8, 2011

(54) Surface Having Superhydrophobic Region And Superhydrophilic Region

(75) Inventors: Aleksandr Bessonov, Suwon-si (KR); Jung Woo Seo, Hwaseong-si (KR); Jeong Gil Kim, Suwon-si (KR); Suk Won Lee, Yongin-si (KR); Jong Woo Lee, Suwon-si (KR); Eun Soo Hwang, Seoul (KR); Young-Tae Cho, Suwon-si (KR)

(73) Assignee: SAMSUNG ELECTRONICS CO., LTD., Suwon-si (KR)

(21) Appl. No.: 13/150,361

(22) Filed: Jun. 1, 2011

(30) Foreign Application Priority Data
Jun. 3, 2010 (KR) 10-2010-0052271

(51) Int. Cl. B32B 3/00

(52) U.S. Cl. 428/195.1

(57) ABSTRACT

According to an example embodiment, a patterned surface includes a micro-structural surface with a micro or nano pattern on a substrate, wherein the micro-structural surface has superhydrophobic regions and superhydrophilic regions.

### CROSS-REFERENCE TO RELATED APPLICATION

This application claims priority under 35 U.S.C. §119 to Korean Patent Application No. 2010-0052271, filed on Jun. 3, 2010 in the Korean Intellectual Property Office, the entire disclosure of which is incorporated herein by reference.

### BACKGROUND

1. Field

Example embodiments relate to a surface structure having superhydrophobic regions and superhydrophilic regions.

2. Description of the Related Art

Nanoimprint lithography is a technique of removing a remaining resist from a pattern. The resist is formed by an imprint process in which a thermoplastic resist or a photocurable resist is applied to a substrate. A mold provided with relief structures of a nano-size is pressurized onto the substrate and then cured to transfer a pattern from the mold to the substrate, using an etching process regardless of the pattern.

The surface of the substrate patterned by the above nanoimprint lithography exhibits excellent wettability, and thus may be manufactured to have hydrophobic regions and hydrophilic regions.

There are several methods to manufacture a surface having hydrophobic regions and hydrophilic regions. For example, a method includes applying a material having hydrophobicity to relief parts of a mold after the general nanoimprint process and then transferring the material from the mold to a surface through a chemical process. A method includes performing O₂ plasma treatment on a resist to provide hydrophilicity, attaching a soft mold made of polydimethylsiloxane (PDMS) having hydrophobicity to the surface of a diaphragm, and then changing only the upper surface of the diaphragm into a state having hydrophobicity by chemical reaction between the polydimethylsiloxane (PDMS) mold and the diaphragm under conditions of a designated temperature and a designated time.

As described above, the conventional methods to manufacture a surface having hydrophobic regions and hydrophilic regions using nanoimprint lithography requires an additional chemical treatment process, and their application is limited. Further, nano structures having hydrophobic regions and hydrophilic regions have any one of hydrophobicity and hydrophilicity, and are used in manufacture of surfaces requiring a combination of hydrophobic regions and hydrophilic regions, for example, displays, bio-analytical instruments, and microfluidic devices.

### SUMMARY

According to an example embodiment, a patterned surface includes a micro-structural surface formed on a substrate. The micro-structural surface has at least one of a micro pattern and a nano pattern. The micro-structural surface includes superhydrophobic regions having a water contact angle (WCA) greater than 120 degrees and superhydrophilic regions having the WCA less than 50 degrees.

According to an example embodiment, the at least one of micro and nano pattern includes a molded polymer material.

According to an example embodiment, the polymer material is at least one of a UV curable aliphatic urethane acrylate-based imprint material of low surface energy having a water contact angle (WCA) of 82 degrees, and a UV curable acrylate-based imprint material of high surface energy having a water contact angle (WCA) of 70 degrees.

According to an example embodiment, dimensions of the micro pattern are in a range of 1˜1,000 μm.

According to an example embodiment, dimensions of the nano pattern are in a range of 10˜1,000 nm.

According to an example embodiment, the nano pattern includes planes exhibiting superhydrophobicity.

According to an example embodiment, the superhydrophobic regions have the water contact angle (WCA) of 120˜180 degrees.

According to an example embodiment, the superhydrophilic regions have the water contact angle (WCA) of 0˜50 degrees.

According to an example embodiment, the micro-structural surface includes nano-patterned projection planes and flat groove planes.

According to an example embodiment, a relief region exhibiting superhydrophobicity is on the nano-patterned projection planes.

According to an example embodiment, a relief region exhibiting superhydrophilicity is on the flat groove planes.

According to an example embodiment, the micro-structural surface includes nano-patterned projection planes and nano-patterned groove planes.

According to an example embodiment, a relief region exhibiting superhydrophilicity is on the nano-patterned groove planes.

According to an example embodiment, the micro-structural surface includes flat projection planes and nano-patterned groove planes.

According to an example embodiment, a relief regions exhibiting superhydrophilicity is on the flat projection planes.

According to an example embodiment, a relief region exhibiting superhydrophobicity is on the nano-patterned groove planes.

According to an example embodiment, the patterned surface, further includes a self-assembled monolayer (SAM) material coating at least a portion of the micro-structural surface.

According to an example embodiment, the self-assembled monolayer (SAM) material has low surface energy.

According to an example embodiment, portions of the micro-structural surface coated with a hydrophilic coating material define the superhydrophobic regions and the superhydrophilic regions.

According to an example embodiment, the hydrophilic coating material has high surface energy.

According to an example embodiment, the substrate is a flexible substrate.

According to an example embodiment, a patterned surface includes a micro-structural surface with a micro pattern on a substrate, the micro-structural surface including projection planes and groove planes; and each of the projection planes and the groove planes including at least one of a nano-patterned plane and a flat plane.

According to an example embodiment, portions of the projection planes and the groove planes coated with a hydrophilic coating material define superhydrophobic regions and superhydrophilic regions, the superhydrophobic regions having a water contact angle (WCA) greater than 120 degrees and the superhydrophilic regions having the WCA less than 50 degrees.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIGS. 1A to 1F are views illustrating a method of forming a patterned surface on a substrate using nanoimprint lithography, according to an example embodiment;

FIG. 2 is a view illustrating a three-dimensional image of a micro-structural surface, according to an example embodiment;

FIG. 3 is a sectional view of the micro-structural surface, according to an example embodiment;

FIG. 4 is an enlarged scanning electron microscopy (SEM) photograph illustrating a projection plane of the micro-structural surface of FIG. 2;

FIG. 5 is an enlarged scanning electron microscopy (SEM) photograph illustrating a groove plane of the micro-structural surface of FIG. 2;

FIGS. 6A and 6B are views illustrating an example of a micro-structural surface having superhydrophobic regions and superhydrophilic regions, according to an example embodiment;

FIGS. 7A to 7C are views illustrating an example of a micro-structural surface having superhydrophobic regions and superhydrophilic regions, according to another example embodiment;

FIG. 8 is a view illustrating an example of a micro-structural surface having superhydrophobic regions and superhydrophilic regions, according to yet another example embodiment; and

FIG. 9 is a view illustrating an example of a micro-structural surface having superhydrophobic regions and superhydrophilic regions, according to an example embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate fog ins and should not be construed as limited to only the embodiments set forth herein.

Accordingly, while example embodiments are capable of various modifications and alternative fauns, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the tee in “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

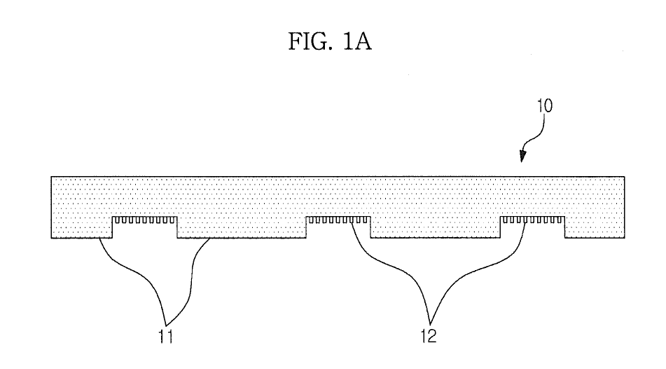

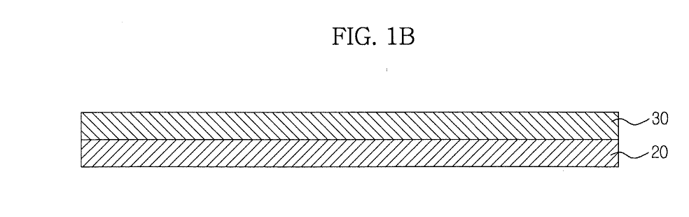

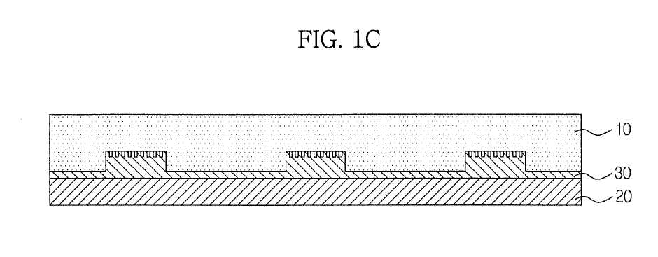

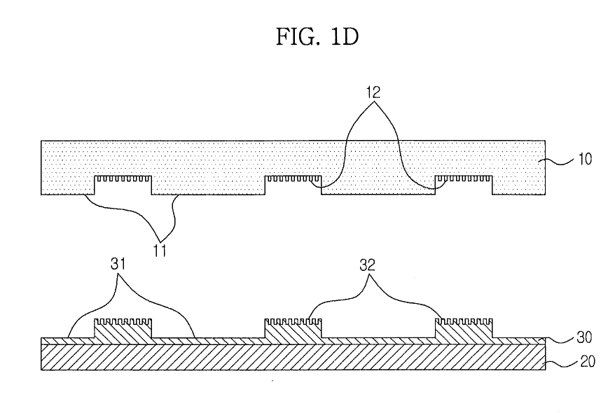

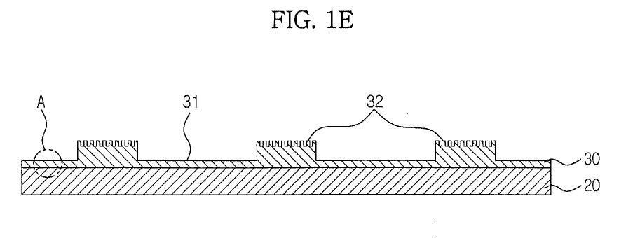

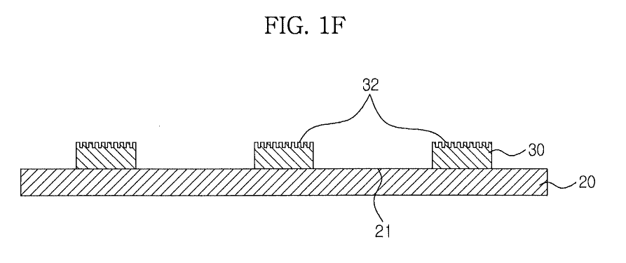

FIGS. 1A to 1F are views illustrating a method of forming a patterned surface on a substrate using nanoimprint lithography, according to an example embodiment.

As shown in FIG. 1A, a mold 10 on which relief parts 11 and intaglio parts 12 are alternately arranged is prepared. The mold 10 is a micro structure on which a micro pattern is carved. The intaglio parts 12 form grooves connecting the neighboring relief parts 11. The surfaces of the relief parts 11 are flat, and the surfaces of the intaglio parts 12 are provided with a plurality of micro protrusions having a width of hundreds of nanometers (nm) to several micrometers (μm).

The micro protrusions of the intaglio parts 12 serve as structures similar to leaves and flowers of the lotus plant, and exhibit the lotus effect of increasing a contact angle to water droplets (water contact angle). These micro protrusions of the intaglio parts 12 may be patterned on the mold 10 using electron beam lithography.

As shown in FIG. 1B, after the preparation of the mold 10, a polymer 30 for imprint is applied to a substrate 20. A hydrophilic polymer resin cured by heat or ultraviolet rays may be used as the polymer 30 for imprint.

A plastic film or a glass substrate may be used as the substrate 20, and be made of a hydrophilic polymer material in the same manner as the polymer 30 for imprint.

As shown in FIG. 1C, pressure is applied to the mold 10 and the substrate 20 under the condition that the relief parts 11 and the micro structures of the intaglio parts 12 of the mold 10 face the upper surface of the polymer 30 for imprint applied to the substrate 20. Thereafter, the polymer 30 for imprint is cured by applying heat or ultraviolet rays thereto. If the ultraviolet rays are applied to the polymer 30 for imprint, the mold 10 is made of a material through which the ultraviolet rays may pass.

As shown in FIG. 1D, the mold 10 is separated from the polymer 30 for imprint of the substrate 20.

As shown in FIG. 1E, when the mold 10 is separated from the polymer 30 for imprint, intaglio parts 31 corresponding to the shape of the relief parts 11 of the mold 10 and relief parts 32 corresponding to the shape of the intaglio parts 12 of the mold 10 are formed on the surface of the polymer 30 for imprint.

That is, the intaglio parts 31 of the polymer 30 for imprint correspond to the shape of the relief parts 11 of the mold 10, and thus have a flat surface.

The relief parts 32 of the polymer 30 for imprint correspond to the shape of the intaglio parts 12 of the mold 10, and thus have a surface provided with a plurality of micro protrusions having a size of hundreds of nanometers (nm) to several micrometers (μm).

Therefore, the polymer 30 for imprint forms a structure having the intaglio parts 31 serving as hydrophilic regions and the relief parts 32 serving as hydrophobic regions.

If the surface of the polymer 30 for imprint is patterned so as to have the intaglio parts 31 as the hydrophilic regions and the relief parts 32 provided with the plural micro protrusions as the hydrophobic regions, as described above, the structure manufactured by the processes, as shown in FIGS. 1A to 1E, is used.

If the intaglio parts 31 having a designated/desired thickness A as the hydrophilic regions of the polymer 30 for imprint applied to the substrate 20 are exposed, an etching process is required.

As shown in FIG. 1F, when the polymer 30 having the thickness A formed at the intaglio parts 31 of the polymer 30 for imprint is removed by the etching process, the upper surface 21 of the substrate 20, from which the polymer 30 having the thickness A is removed, is exposed. Thereby, the external surface of the substrate 20 forms a micro-structural surface on which only the relief parts 32 of the polymer 30 for imprint remain.

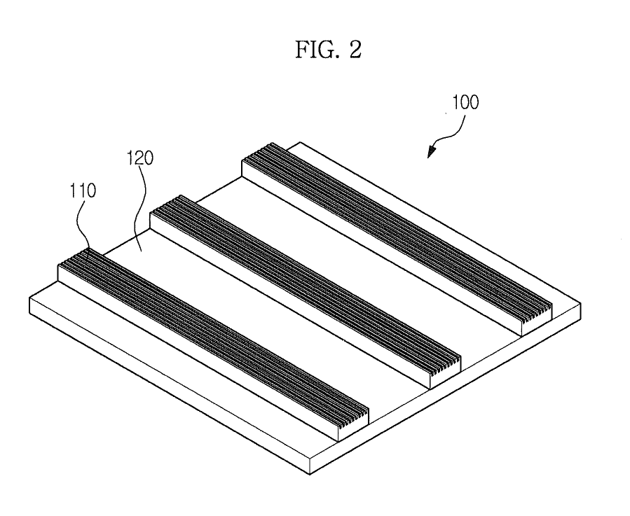

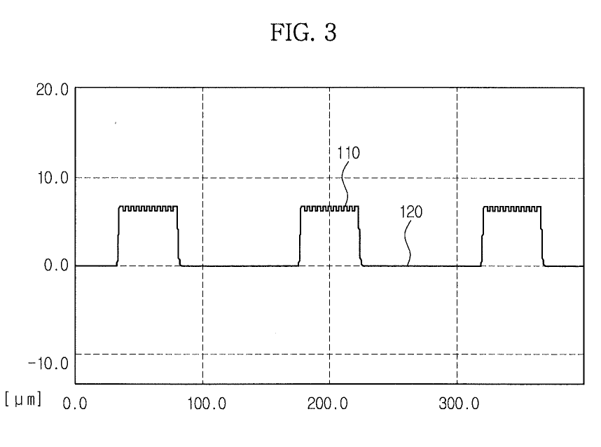

FIGS. 2 and 3 illustrate the micro-structural surface formed by the nanoimprint lithography of FIGS. 1A to 1F.

FIG. 2 is a view illustrating a three-dimensional image of the micro-structural surface, according to an example embodiment, and FIG. 3 is a sectional view of the micro-structural surface, according to an example embodiment.

With reference to FIGS. 2 and 3, a micro-structural surface 100 formed on the substrate 20 is manufactured in a micro stripe shape having projection planes 110 having a width of 50 μm and groove planes 120 having a width of 100 μm by the nanoimprint lithography using an imprint material (for example, a polymer) having an inherent water contact angle.

Here, the projection planes 110 of the micro-structural surface 100 correspond to the relief parts 32 of the polymer 30 for imprint formed by the nanoimprint lithography of FIGS. 1A to 1F, and the groove planes 120 of the micro-structural surface 100 correspond to the exposed upper surface 21 of the substrate 20 obtained by the nanoimprint lithography of FIGS. 1A to 1F.

Such a micro-structural surface 100 in the micro stripe shape having the projection planes 110 having a width of 50 μm and the groove planes 120 having a width of 100 μm uses a UV lamp having a wavelength of 365 nm and a strength of 20 mW/cm² as a transmitting light source, and in order to reproduce a precise nano or micro pattern, the surface of the mold 10 undergoes adhesion prevention coating treatment prior to imprint.

The manufactured micro-structural surface 100 in the micro stripe shape is provided with nano pillars irregularly/randomly arranged on the projection planes 110 and the flat surfaces of the groove planes 120 by a single process using the nanoimprint mold 10 designed to have a designated/desired nano pattern. The projection planes 110 have a height in the range of 1˜20 μm.

The patterned surfaces of the projection planes 110 with the nano pillars fowls superhydrophobic regions due to the lotus effect of increasing a contact angle of water droplets (i.e. a water contact angle), and the surfaces of the groove planes 120 form hydrophilic regions.

In general, hydrophobic regions and hydrophilic regions are defined by measuring the water contact angle (WCA). Measurement of the water contact angle is known technology to research and control surface treatment, cleaning, and surface modification. The water contact angle is an angle between an inclination of a water droplet profile and an inclination of a surface at a cross point among gas, liquid, and solid, and is an index indicating humidity. The smaller the water contact angle is, higher the surface energy is, i.e., the surface exhibits hydrophilicity having excellent wetting behavior. The larger the water contact angle is, lower the surface energy is, i.e., the surface exhibits hydrophobicity having poor wetting behavior.

In general, if the water contact angle exceeds 90 degrees, the surface exhibits hydrophobicity, and if the water contact angle is less than 90 degrees, the surface exhibits hydrophilicity. Further, if the water contact angle is 120 degrees or more, the surface exhibits ultrahydrophobicity having the poorer wetting behavior than hydrophobicity, if the water contact angle is 150 degrees or more, the surface exhibits superhydrophobicity having extremely poor wetting behavior, and if the water contact angle is less than 10 degrees, the surface exhibits superhydrophilicity having extremely excellent wetting behavior.

A superhydrophobic material protects a surface from moisture and contaminants and thus maintains a dry and clean state of the surface. Such a material is used in a variety of consumable goods. Further, a superhydrophilic material has immediate wettability. Such a surface is also used in a variety of consumable goods. For example, an electronic element requiring complete distribution of functional inks in a channel is processed to have a superhydrophilic surface having an excellent wetting effect.

Additionally, a combination of superhydrophobic regions and superhydrophilic regions is required on a single surface in many consumable good fields, for example, manufacture of displays, bio-analytical instruments, and microfluidic devices.

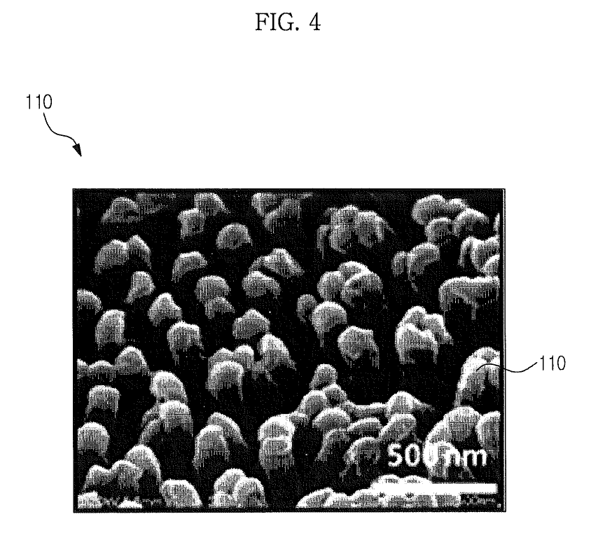

FIG. 4 is an enlarged scanning electron microscopy (SEM) photograph illustrating the projection plane of the micro-structural surface of FIG. 2.

As shown in FIG. 4, the projection plane 110 of the micro-structural surface 100 has a nano-patterned surface including a plurality of nano pillars 111 like structures provided on leaves and flowers of the lotus plant.

The nano-patterned surface of the projection plane 110 is varied according to a size of the nano pillars 111 and a gap between the nano pillars 111. FIG. 4 exemplarily illustrates the nano pillars 111 having a height of 350˜400 nm, a width of about 100 nm, and a gap of 200˜300 nm between the nano pillars 111. The nano pillars 111 are obtained by imprint treatment of an anodic aluminum oxide surface with pores having a size corresponding to that of the nano pillars 111.

Wettability and other properties of the nano-patterned surface may be adjusted according to micro or nano structures. Micro and nano structures are widely used in many application fields and industries and newly-developed technologies, and an excellently designed nano-patterned surface exhibits superhydrophobicity, such as water resistance, and thus has a wetting effect or a self-cleaning effect. A superhydrophobic surface may cause roll-off due to a high water contact angle and low magnetic hysteresis thereof, and a nano-patterned surface combined with a specific material may exhibit superhydrophilic behavior, i.e. may be wetted immediately.

Therefore, the nano-patterned surface selectively undergoes selective wetting treatment using water or other hydrophilic liquids, and thus has a selective combination of superhydrophobic regions and superhydrophilic regions through a single process without any chemical treatment process.

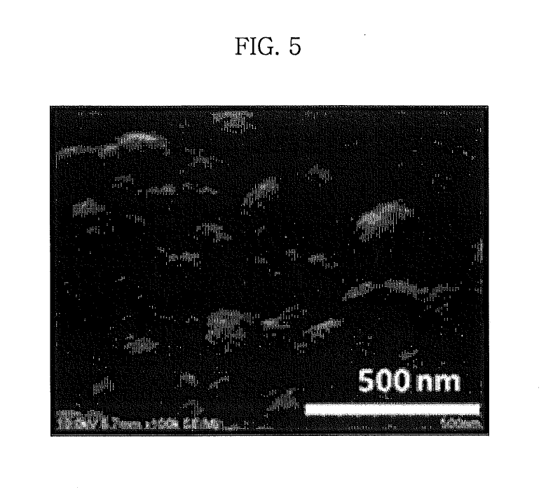

FIG. 5 is an enlarged scanning electron microscopy (SEM) photograph illustrating the groove plane of the micro-structural surface of FIG. 2.

As shown in FIG. 5, the groove plane 120 of the micro-structural surface 100 has a relatively flat surface.

Hereinafter, prior to illustration of manufacture of a surface selectively having superhydrophobic regions and superhydrophilic regions through a single process, “superhydrophobicity”, which will be described below, is defined to include ultrahydrophobicity and superhydrophobicity in which the water contact angle is in the range of 120˜180 degrees.

An example embodiment illustrates the large-size patterned hard or flexible substrate 20. Since the substrate 20 has a combination of superhydrophobic and hydrophilic properties or a combination of superhydrophobic and superhydrophilic properties according to positions on a designated/desired portion of the substrate 20, humidity of the substrate 20 is adjusted. In order to achieve selective superhydrophobicity and superhydrophilicity on the single substrate 20, four relative approaches below are carried out.

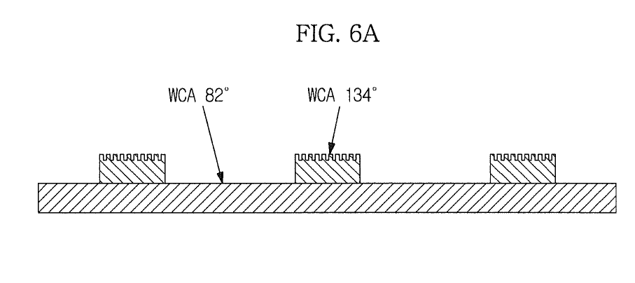

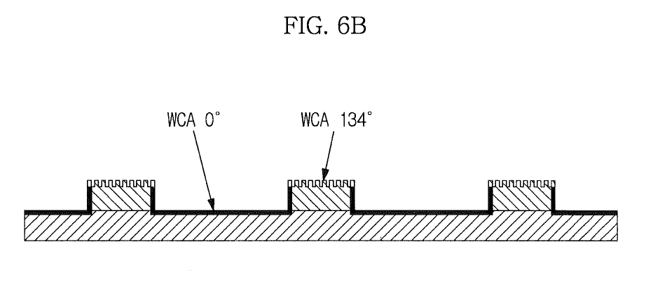

First, a patterning process of a low surface energy imprint material is carried out by forming a superhydrophobic nano pattern on the projection planes 110 and then performing superhydrophilic treatment on the flat groove planes 120 by forming an aqueous hydrophilic coating material (with reference to FIGS. 6A and 6B).

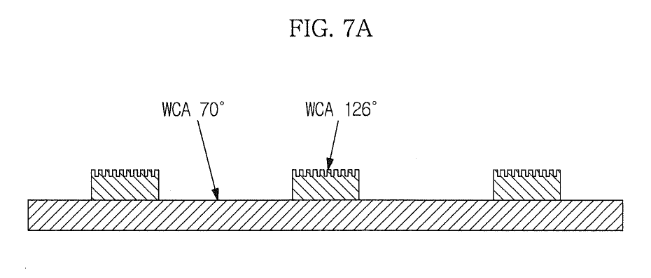

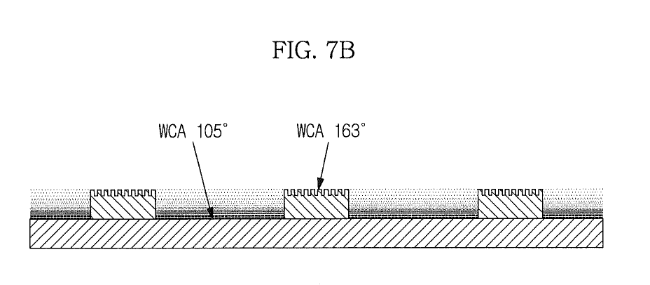

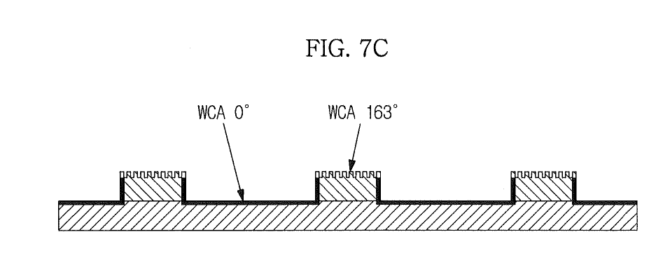

Second, a patterning process of a high surface energy imprint material is carried out by forming a superhydrophobic nano pattern on the projection planes 110 and then performing superhydrophilic treatment on the flat groove planes 120 by, for example, forming a self-assembled fault, such as an octadecyltrichlorosilane self-assembled monolayer (OTS-SAM) decreasing surface energy and forming a aqueous hydrophilic coating material (with reference to FIGS. 7A and 7B).

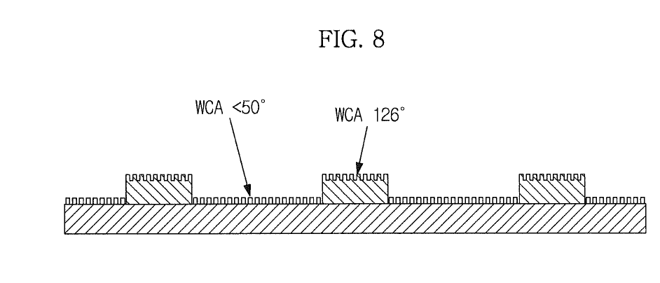

Third, a patterning process of a high surface energy imprint material is carried out by forming nano-patterned superhydrophobic projection planes 110 and imprinting a nano pattern in a designated/desired design on the superhydrophilic groove planes 120 using the same imprint polymer material, simultaneously (with reference to FIG. 8).

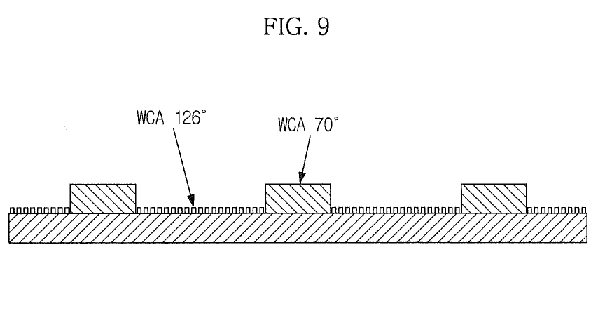

Fourth, a patterning process of an imprint material is carried out by forming a superhydrophobic nano pattern on the groove planes 120 and, for example, forming a self-assembled fault decreasing surface energy or performing aqueous hydrophilic coating increasing surface energy. Further, simultaneously, wettability treatment based on hydrophilicity may be formed on the projection planes 110 (with reference to FIG. 9).

Now, the four approaches above, according to example embodiments, will be described in detail with reference to FIGS. 6A to 9.

FIGS. 6A and 6B are views illustrating an example of a micro-structural surface having superhydrophobic regions and superhydrophilic regions, according to an example embodiment.

As shown in FIG. 6A, a micro-structural surface 100 in a micro stripe shape having projection planes 110 having a width of 50 μm and groove planes 120 having a width of 100 μm is manufactured by the nanoimprint lithography using a UV curable aliphatic urethane acrylate-based imprint material (for example, a polymer) having low surface energy, the water contact angle (INCA) of which is 82 degrees.

The manufactured micro-structural surface 100 in the micro stripe shape has nano pillars 111 irregularly arranged on the projection planes 110 and flat surfaces of the groove planes 120 through a single process using a nanoimprint mold 10 designed to have a designated nano pattern. Here, the projection planes 110 have a height in the range of 1˜20 μm.

The nano pillars 111 on the projection planes 110 are formed in an irregular nano pattern having variables, such as a height of 350˜400 nm, a width of about 100 nm, and a gap of 200˜300 nm between the nano pillars 111.

As a result of measurement of water contact angles (WCA) of the micro-structural surface 100 manufactured in FIG. 6A, the nano-patterned projection planes 110 form superhydrophobic regions having a water contact angle (WCA) of 134 degrees due to superhydrophobicity of the nano pillars 111, and the flat groove planes 120 form superhydrophilic regions having a water contact angle (WCA) of 82 degrees, for example, the water contact angle (WCA) of the imprint material.

As shown in FIG. 6B, the micro-structural surface 100 manufactured in FIG. 6A is treated using an aqueous hydrophilic coating material by, for example, a slit coating method, a dip coating method, or a spin coating method. During this process, the nano-patterned projection planes 110 maintain a dry and clean state due to superhydrophobicity thereof. On the other hand, the flat groove planes 120 are coated with a thin hydrophilic coating material having a water contact angle (WCA) of less than 30 degrees. If a specific aqueous hydrophilic coating material is used, a coating thickness of a sub micron level and a water contact angle (WCA) of about 0 degrees are achieved after drying, and thus the groove planes 120 exhibit superhydrophilicity.

For example, methoxy poly(ethylene glycol), styrene-maleic anhydride, or aqueous styrene-acrylic acid solution may be used as the aqueous hydrophilic coating material.

As such, selective wetting treatment of the micro-structural surface 100 is achieved so that the superhydrophobic regions or the superhydrophilic regions selectively collect moisture within the groove planes 120, and the nano-patterned projection planes 110 maintain a dry and clean state based on superhydrophobicity and water repellency.

As a result of measurement of water contact angles (WCA) of the micro-structural surface 100 obtained in FIG. 6B, the nano-patterned projection planes 110 after the aqueous hydrophilic coating treatment have the same water contact angle (WCA) of 130˜140 degrees (for example, 134 degrees) as the nano-patterned projection planes 110 before the aqueous hydrophilic coating treatment. On the other hand, the flat groove planes 120 after the aqueous hydrophilic coating treatment form superhydrophilic regions having a water contact angle (WCA) of 0˜30 degrees (for example, 0 degrees).

Therefore, the micro-structural surface 100 having the superhydrophobic projection planes 110 having the water contact angle (WCA) of 130˜140 degrees (for example, 134 degrees) and the superhydrophilic groove planes 120 having the water contact angle (WCA) of 0˜30 degrees (for example, 0 degrees) is formed on the hard or flexible substrate 20 as shown in the example embodiment of FIGS. 6A and 6B.

FIGS. 7A to 7C are views illustrating an example of a micro-structural surface having superhydrophobic regions and superhydrophilic regions, according to another example embodiment.

As shown in FIG. 7A, a micro-structural surface 100 in a micro stripe shape having projection planes 110 having a width of 50 μm and groove planes 120 having a width of 100 μm is manufactured by the nanoimprint lithography using a UV curable acrylate-based imprint material having high surface energy, the water contact angle (WCA) of which is 70 degrees.

The manufactured micro-structural surface 100 in the micro stripe shape has nano pillars 111 irregularly arranged on the projection planes 110 and flat surfaces of the groove planes 120 through a single process using a nanoimprint mold 10 designed to have a designated nano pattern. Here, the projection planes 110 have a height in the range of 1˜20 μm.

The nano pillars 111 on the projection planes 110 are formed in an irregular nano pattern having variables, such as a height of 350˜400 nm, a width of about 100 nm, and a gap of 200˜300 nm between the nano pillars 111.

As a result of measurement of water contact angles (WCA) of the micro-structural surface 100 manufactured in FIG. 7A, the nano-patterned projection planes 110 form superhydrophobic regions having a water contact angle (WCA) of 126 degrees due to superhydrophobicity of the nano pillars 111, and the flat groove planes 120 form superhydrophilic regions having a water contact angle (WCA) of 70 degrees, for example, the water contact angle (WCA) of the imprint material.

As shown in FIG. 7B, the micro-structural surface 100 manufactured in FIG. 7A, is coated with a self-assembled fault, for example, an octadecyltrichlorosilane self-assembled monolayer (OTS-SAM). Such a low energy coating material may be deposited on a surface, on which Ultra Violet Ozone (UVO) treatment is performed in advance, obtained from a nucleic acid solution to form a hydrophobic fault having a normal water contact angle (WCA) of about 100˜105 degrees. In the micro-structural surface 100 of FIG. 7B, the flat groove planes 120 exhibit a water contact angle (WCA) of about 105 degrees, and the nano-patterned projection planes 110 exhibit a water contact angle (WCA) of about 163 degrees. The projection planes 110 coated with the octadecyltrichlorosilane self-assembled monolayer (OTS-SAM) fault serve as an excellent superhydrophobic surface not exhibiting wetting behavior. These planes 110 have a roll-off angle of less than 20 degrees.

By theoretical calculation based on the Cassie-Wenzel model, the water contact angle (WCA) of the nano-patterned planes having the water contact angle (WCA) of 105 degrees is calculated to be 157˜162 degrees, and the calculated angle almost coincides with the measured angle of 163 degrees.

As shown in FIG. 7C, the micro-structural surface 100 coated with the octadecyltrichlorosilane self-assembled monolayer (OTS-SAM) fault is treated using an aqueous hydrophilic coating material by a slit coating method, a dip coating method, or a spin coating method. During this process, the nano-patterned projection planes 110 maintain a dry and clean state due to superhydrophobicity and water repellency thereof. On the other hand, the flat groove planes 120 are coated with a thin hydrophilic coating material having a water contact angle (WCA) of less than 30 degrees. If a specific aqueous hydrophilic coating material is used, a coating thickness of a sub micron level and a water contact angle (WCA) of about 0 degrees are achieved after drying, and thus the groove planes 120 exhibit superhydrophilicity.

For example, methoxy poly(ethylene glycol), styrene-maleic anhydride, or aqueous styrene-acrylic acid solution may be used as the aqueous hydrophilic coating material.

As such, selective wetting treatment of the micro-structural surface 100 is achieved so that the superhydrophobic regions or the superhydrophilic regions selectively collect moisture within the groove planes 120, and the nano-patterned projection planes 110 maintain a dry and clean state based on superhydrophobicity and water repellency.

As a result of measurement of water contact angles (WCA) of the micro-structural surface 100 obtained in FIG. 7C, the nano-patterned projection planes 110 after the octadecyltrichlorosilane self-assembled monolayer (OTS-SAM) fault treatment and the aqueous hydrophilic coating treatment form superhydrophobic regions having a water contact angle (WCA) of 160˜170 degrees (for example, 163 degrees). On the other hand, the flat groove planes 120 after the octadecyltrichlorosilane self-assembled monolayer (OTS-SAM) fault treatment and the aqueous hydrophilic coating treatment form superhydrophilic regions having a water contact angle (WCA) of 0˜30 degrees (for example, 0 degrees).

Therefore, the micro-structural surface 100 having the superhydrophobic projection planes 110 having the water contact angle (WCA) of 160˜170 degrees (for example, 163 degrees) and the superhydrophilic groove planes 120 having the water contact angle (WCA) of 0˜30 degrees (for example, 0 degrees) is formed on the hard or flexible substrate 20 as illustrated in the example embodiments of FIGS. 7A to 7C.

FIG. 8 is a view illustrating an example of a micro-structural surface having superhydrophobic regions and superhydrophilic regions, according to another example embodiment.

As shown in FIG. 8, a micro-structural surface 100 in a micro stripe shape having projection planes 110 having a width of 50 μm and groove planes 120 having a width of 100 μm is manufactured by the nanoimprint lithography using an imprint material having high surface energy, the water contact angle (WCA) of which is less than 70 degrees.

The manufactured micro-structural surface 100 in the micro stripe shape has nano pillars 111 irregularly arranged on the projection planes 110 and a specifically designed nano pattern on the groove planes 120 through a single process using a nanoimprint mold 10 designed to have a designated nano pattern. Here, the projection planes 110 have a height in the range of 1˜20 μm.

The nano pillars 111 on the projection planes 110 are fat wed in an irregular nano pattern having variables, such as a height of 350˜400 nm, a width of about 100 nm, and a gap of 200˜300 nm between the nano pillars 111.

Nano pillars on the groove planes 120 are designed so as to provide superhydrophilicity and superior wettability. Here, the nano pillars 111 on the projection planes 110 are formed in a designated/desired nano pattern having variables, such as a height of 100˜200 nm, and a gap of 800˜1,200 nm between the nano pillars.

As a result of measurement of water contact angles (WCA) of the manufactured micro-structural surface 100, the nano-patterned projection planes 110 form superhydrophobic regions having a water contact angle (WCA) of 126 degrees due to superhydrophobicity of the nano pillars 111, and the groove planes 120 having the designated nano pattern form hydrophilic regions having a water contact angle (WCA) of 50 degrees due to hydrophilicity of the designated/desired nano pattern.

If needed, the manufactured micro-structural surface 100 is treated using an aqueous hydrophilic coating material by a slit coating method, a dip coating method, or a spin coating method. During this process, the nano-patterned projection planes 110 maintain a dry and clean state due to superhydrophobicity thereof. On the other hand, the flat groove planes 120 having the designated/desired nano pattern are coated with a thin hydrophilic coating material having a water contact angle (WCA) of about 0 degrees due to hydrophilicity of the nano-patterned planes 120.

As a result of measurement of water contact angles (WCA) of the manufactured micro-structural surface 100 after the aqueous hydrophilic coating material treatment, the nano-patterned projection planes 110 form superhydrophobic regions having a water contact angle (WCA) of 120˜130 degrees (for example, 126 degrees) due to superhydrophobicity of the nano pillars 111, and the groove planes 120 having the designated nano pattern form hydrophilic regions having a water contact angle (WCA) of less than 50 degrees due to hydrophilicity of the designated nano pattern.

Therefore, the micro-structural surface 100 having the superhydrophobic projection planes 110 having the water contact angle (WCA) of 120˜130 degrees (for example, 126 degrees) and the groove planes 120 having the water contact angle (WCA) of less than 50 degrees is formed on the hard or flexible substrate 20, according to the example embodiment of FIG. 8.

FIG. 9 is a view illustrating an example of a micro-structural surface having superhydrophobic regions and superhydrophilic regions, according to an example embodiment.

As shown in FIG. 9, a micro-structural surface 100 in a micro stripe shape having projection planes 110 having a width of 50 μm and groove planes 120 having a width of 100 μm is manufactured by the nanoimprint lithography using a UV curable acrylate-based imprint material having high surface energy, the inherent water contact angle (WCA) of which is 70 degrees, for example, OER-08 (Minuta Technology Co.).

The manufactured micro-structural surface 100 in the micro stripe shape has flat surfaces of the projection groves 110 and a specifically designed nano pattern on the groove planes 120 through a single process using a nanoimprint mold 10 designed to have the designated/desired nano pattern. Here, the projection planes 110 have a height in the range of 1˜20 μm.

Nano pillars on the groove planes 120 are formed in an irregular nano pattern having variables, such as a height of 350˜400 nm, a width of about 100 nm, and a gap of 200˜300 nm between the nano pillars.

As a result of measurement of water contact angles (WCA) of the manufactured micro-structural surface 100, the flat projection planes 110 form hydrophilic regions having a water contact angle (WCA) of 70 degrees, for example, the water contact angle (WCA) of the imprint material, and the nano-patterned groove planes 120 form hydrophobic regions having a water contact angle (WCA) of 126 due to superhydrophobicity of the nano pillars.

If needed, the manufactured micro-structural surface 100 is coated with a self-assembled fault, for example, an octadecyltrichlorosilane self-assembled monolayer (OTS-SAM). Such a low energy coating material may be deposited on a surface, on which Ultra Violet Ozone (UVO) treatment is performed in advance, obtained from a nucleic acid solution to faun a hydrophobic fault having a normal inherent water contact angle (WCA) of about 100˜105 degrees. In the micro-structural surface 100, the flat projection planes 110 exhibit a water contact angle (WCA) of about 105 degrees, and the nano-patterned groove planes 120 exhibit a water contact angle (WCA) of about 163 degrees. The groove planes 120 coated with the octadecyltrichlorosilane self-assembled monolayer (OTS-SAM) fault serve as an excellent superhydrophobic surface not exhibiting wetting behavior. These planes 120 have a roll-off angle of less than 20 degrees.

Further, the manufactured micro-structural surface 100 is treated using an aqueous hydrophilic coating material by a slit coating method, a dip coating method, or a spin coating method. During this process, the nano-patterned groove planes 120 maintain a dry and clean state due to superhydrophobicity and water repellency thereof. On the other hand, the flat projection planes 110 are coated with a thin hydrophilic coating material having a water contact angle (WCA) of less than 30 degrees. If a specific aqueous hydrophilic coating material is used, a coating thickness of a sub micron level and a water contact angle (WCA) of about 0 degrees are achieved after drying, and thus the flat projection planes 110 exhibit superhydrophilicity.

For example, methoxy polyethylene glycol), styrene-maleic anhydride, or aqueous styrene-acrylic acid solution may be used as the aqueous hydrophilic coating material.

As such, selective wetting treatment of the micro-structural surface 100 is achieved so that the superhydrophobic regions or the superhydrophilic regions selectively collect moisture within the groove planes 120 and the nano-patterned groove planes 120 maintain a dry and clean state based on superhydrophobicity and water repellency thereof.

Therefore, the micro-structural surface 100 having the superhydrophobic groove planes 120 having the water contact angle (WCA) of 120˜130 degrees (for example, 126 degrees) and the hydrophilic projection planes 110 having the water contact angle (WCA) of 70 degrees is formed on the hard or flexible substrate 20, according to an example embodiment of FIG. 9.

As is understood from the above description, according to an example embodiment, large-sized pattern treatment is carried out through a single process without an additional chemical treatment process, thereby forming a patterned surface having superhydrophobic regions and superhydrophilic regions on a single surface.

Further, the surface selectively having superhydrophobic regions and superhydrophilic regions is manufactured with relative ease using a hydrophilic coating method, micro relief planes selectively having superhydrophobic regions and superhydrophilic regions are manufactured in a single process without separate processing treatment, and selectively wetting treatment is carried out using water or other hydrophilic liquids. Therefore, the patterned surface having superhydrophobic regions and superhydrophilic regions may be manufactured by simple hydrophilic coating treatment.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A patterned surface, comprising:
a micro-structural surface formed on a substrate, the micro-structural surface having at least one of a micro pattern and a nano pattern, and the micro-structural surface having superhydrophobic regions having a water contact angle (WCA) greater than 120 degrees and superhydrophilic regions having the WCA less than 50 degrees.

2. The patterned surface according to claim 1, wherein the at least one of micro and nano pattern includes a molded polymer material.

3. The patterned surface according to claim 2, wherein the polymer material is at least one of a UV curable aliphatic urethane acrylate-based imprint material of low surface energy having a water contact angle (WCA) of 82 degrees, and a UV curable acrylate-based imprint material of high surface energy having a water contact angle (WCA) of 70 degrees.

4. The patterned surface according to claim 1, wherein dimensions of the micro pattern are in a range of 1˜1,000 μm.

5. The patterned surface according to claim 1, wherein dimensions of the nano pattern are in a range of 10˜1,000 nm.

6. The patterned surface according to claim 5, wherein the nano pattern includes planes exhibiting superhydrophobicity.

7. The patterned surface according to claim 1, wherein the superhydrophobic regions have the water contact angle (WCA) of 120˜180 degrees.

8. The patterned surface according to claim 1, wherein the superhydrophilic regions have the water contact angle (WCA) of 0˜50 degrees.

9. The patterned surface according to claim 1, wherein the micro-structural surface includes nano-patterned projection planes and flat groove planes.

10. The patterned surface according to claim 9, wherein a relief region exhibiting superhydrophobicity is on the nano-patterned projection planes.

11. The patterned surface according to claim 9, wherein a relief region exhibiting superhydrophilicity is on the flat groove planes.

12. The patterned surface according to claim 1, wherein the micro-structural surface includes nano-patterned projection planes and nano-patterned groove planes.

13. The patterned surface according to claim 12, wherein a relief region exhibiting superhydrophobicity is on the nano-patterned projection planes.

14. The patterned surface according to claim 12, wherein a relief region exhibiting superhydrophilicity is on the nano-patterned groove planes.

15. The patterned surface according to claim 1, wherein the micro-structural surface includes flat projection planes and nano-patterned groove planes.

16. The patterned surface according to claim 15, wherein a relief regions exhibiting superhydrophilicity is on the flat projection planes.

17. The patterned surface according to claim 15, wherein a relief region exhibiting superhydrophobicity is on the nano-patterned groove planes.

18. The patterned surface according to claim 2, further comprising:
a self-assembled monolayer (SAM) material coating at least a portion of the micro-structural surface.

19. The patterned surface according to claim 18, wherein the self-assembled monolayer (SAM) material has low surface energy.

20. The patterned surface according to claim 1, wherein portions of the micro-structural surface coated with a hydrophilic coating material define the superhydrophobic regions and the superhydrophilic regions.

21. The patterned surface according to claim 20, wherein the hydrophilic coating material has high surface energy.

22. The patterned surface according to claim 20, wherein the substrate is a flexible substrate.

23. A patterned surface, comprising:
a micro-structural surface with a micro pattern on a substrate, the micro-structural surface including projection planes and groove planes; and each of the projection planes and the groove planes including at least one of a nano-patterned plane and a flat plane.

24. The patterned surface according to claim 23, wherein portions of the projection planes and the groove planes coated with a hydrophilic coating material define superhydrophobic regions and superhydrophilic regions, the superhydrophobic regions having a water contact angle (WCA) greater than 120 degrees and the superhydrophilic regions having the WCA less than 50 degrees.
